(19) United States
(12) Patent Application Publication
(10) Pub. No.: US 2010/0082876 A1
(43) Pub. Date: Apr. 1, 2010

(54) System and method of use of fast updatable counters using dynamic random access memories

(76) Inventors: Deepak Lala, Fremont, CA (US); Umesh Ramkreshnarao Kasture, Pune (IN)

Correspondence Address: PATRICK REILLY, P.O. BOX 7218, SANTA CRUZ, CA, 95061-7218, US

(21) Appl. No.: 12/286,121

(22) Filed: Sep. 26, 2008

(51) Int. Cl. G06F 12/06

(52) U.S. Cl. 711/5; 711/105; 711/E12.084; 711/E12.082

(57) ABSTRACT

A system and method for enabling one or more memories to maintain, update, and provide counter values. In a first version a dynamic random access memory, or DRAM, is bi-directionally communicatively coupled with a processor. The DRAM is divided into a plurality of banks. In the first version a set of subcounters is established, wherein each subcounter element is separately and singly located within a different DRAM bank. The value of a counter can be derived by reading and processing, e.g., adding, all of the values of each of an assigned set of subcounter subvalues maintained within the plurality of banks. Conversely, a counter value may be updated by updating a single assigned subcounter of a single bank. The first method allows a hosting computer to select a subcounter having a shortest access time, where the subcounter is an element of a set of subcounters assigned to maintain a given counter value.

### BACKGROUND OF THE INVENTION

1. Field of the Invention

The present invention relates generally to updating, applying and updating counters in electronic computation systems. More particularly, the present invention relates to using semiconductor memory devices to update, maintain and act upon values.

2. Description of the Background Art

Computational methods often require the use of counters that maintain values that are used to direct a host computer to take an action upon the basis of the counter value. Counter values may be maintained in external memory circuits that reside off-chip from a processor that directs the updating of the counter values. The access time of the memory in accepting commands and data from the processor can therefore be critically important in the efficiency of updating, maintaining, and employing the counter values.

The updating of the counter values may be additive, i.e., by incrementing a counter value, or by application of an algorithm.

Other prior art techniques distribute counters between resources that are on-chip with a processor and off-chip of the process. Most typically, counter values that are selected as being most likely to effect the efficiency of a hosting computer are stored in on-chip resources, and counter values that are less likely to effect computational efficiency are stored in off-chip resources. The number of on-chip memories can therefore limit the effectiveness of the on-chip/off-chip counter resource design.

Certain prior art computer designs employ memory devices that exhibit faster access time, such as commercially available static random access memory devices, reduced latency dynamic random access memory, extended data out dynamic random access memory, burst extended data out dynamic random access memory. Other prior art techniques use multibank dynamic random access memory devices that divide a memory into small memory counters, e.g., 256 Kbytes, and enable operations to be applied to two different banks in a single clock cycle.

Many prior art networking computer systems employ 100,000 counters or more as packet counters and byte counters. These packet and byte counters may be maintained for variety of reasons including, but not limited to, logging, reporting, and debugging operations. Computational processing of electronic messaging between a network computer and an electronics communications network, e.g., the Internet, may require that counters be updated at a very high rate, e.g. for XAUI interfaces, the preferred rate may be 14.88 million counter value updates per second. In the prior art techniques of assigning a single location within an electronic device or circuit to maintain a current value of a particular counter, the access time of the device to read from or write to the single location of the device may be limited to a imposing a frequency of possible access that is lower than the rate at which updates of the counter value are generated or received. It is understood that the single location of the device or circuit may comprise a plurality of reprogrammable memory circuits that are capable of storing values greater than a magnitude of plus or minus 100,000,000 counts.

For counters with such high update rates, on-chip implementation of each counter is favoured to maintain desirable performance levels, but this approach is not desirable above 100,000 on-chip counters.

There is therefore a long felt need to provide techniques that enable high update rates of counters, i.e., above ten million counter updates per second, by means that employ off-chip, lower cost random access memories that have access times slower than provided by on-chip memories.

### SUMMARY OF THE INVENTION

Towards this object and other objects that will be made obvious in light of this disclosure, a first alternate preferred embodiment of the method present invention provides a method and system that enables one or more dynamic random access memories to maintain, update, and provide counter values. In the first alternate preferred embodiment of the method present invention, or first method, a dynamic random access memory, or DRAM, is bi-directionally communicatively coupled with a processor. The DRAM has plurality of memory resources that are divided into a plurality of banks. In the first method each bank is assigned to maintain a plurality of subcounters, each subcounter capable of maintaining and receiving updates of a subcounter value, i.e., a subvalue. A subcounter may be or comprise a bin of a bank. A subcounter is a portion of a bank to which subvalues may be written to, read from, and updated by overwriting with an updated subcounter value and/or deleting a previous subcounter value and writing in an updated subcounter value into the bin. The terms subcounter value and subvalue are synonyms having identical meanings within the present disclosure.

In accordance with the method of the present invention, sets of subcounters are established, wherein each unique subcounter set may be assigned and applied in the aggregate to maintain a unique counter value. Each subcounter of a given subcounter set may be maintained within a different bank. The value of a counter can be derived by reading and cumulating each subvalue of an assigned set of subcounters, optionally wherein each unique and individual subcounter of a particular subcounter set may be maintained within a unique bank of the plurality of banks, and wherein bank maintains more than one subcounter of each separate subcounter set. For example, a first counter value may be derived by reading and processing each of a plurality of subvalues, wherein each subvalue is separately stored in each of a first subcounter of each of eight or more banks of the DRAM. Additionally or alternatively, the first counter value may be updated by merely updating a single assigned subcounter of a single bank. Certain alternate preferred embodiments of the method of the present invention direct a hosting computer to select a subcounter for use in updating a particular counter value by selecting a subcounter that is (a.) of a subcounter set that is assigned to that particular, i.e., the instant or associated, counter value; and (b.) is determined to have an acceptably short determined, apparent or indicated access time required to perform a subcounter update. Alternatively or additionally, a host computer may be directed to apply a subcounter selection standard that leads the host computer to select a subcounter for updating that presents a smallest determined, apparent or indicated access time of some or all of the subcounters assigned to a particular subcounter set that is assigned to the relevant associated counter value, i.e., the instant counter value.

In certain even alternate preferred embodiments of the present invention, one or more banks of the DRAM may maintain 100,000 or more sub counters, and each subcounter is assigned to maintaining a subvalue of a counter value. Each counter value may be derived by reading a single subcounter value, i.e., individual subvalues, stored in each subcounter, from each bank and adding the plurality of read subvalues to generate the counter value. The subcounters are organized into subcounter sets, wherein the subcounter sets consist of subcounter elements that are each located singly and separately in different banks. In other words, each bank may include one and only one subcounter of each subcounter set, and the subcounter set is stored distributively among the banks in a single subcounter element per bank basis.

In certain still alternate preferred embodiments of the present invention, a counter value is derived by reading each subcounter value from a subcounter element of each bank and applying a counter value algorithm to the subcounter values. Computing the counter value algorithm may include or comprise summing or additive processing, and/or other suitable computational operations known in the art. Additionally or alternatively, in various yet alternate preferred embodiments of the present invention, updating subcounter values may be accomplished by algorithms that include or consist of incrementing a subcounter value, an additive process, a subtractive process, a multiplicative process and/or a logical operation.

It is understood that certain other alternate embodiments of the method of the present invention may be employed in a suboptimal basis, wherein not all of the banks of the DRAM are used to store subcounter values, and/or a subcounter exhibiting the shortest current access time is not always or consistently selected for immediate updating. In still other alternate preferred embodiments of the present invention more than one subvalue counter of a same subcounter set may be located within a same bank.

The foregoing and other objects, features and advantages will be apparent from the following description of the preferred embodiment of the invention as illustrated in the accompanying drawings.

### INCORPORATION BY REFERENCE

U.S. Pat. No. 7,366,865 (Inventors: Lakshmanamurthy, et al.; Apr. 29, 2008) entitled “Enqueueing entries in a packet queue referencing packets”; U.S. Pat. No. 7,366,171 (Inventors: Kadambi, et al.; issued on Apr. 29, 2008) entitled “Network switch”; U.S. Pat. No. 7,349,405 (Inventor: Deforche, K.; issued on Mar. 25, 2008) entitled “Method and apparatus for fair queuing of data packets”; U.S. Pat. No. 7,349,398 (Inventors: Favor, et al.; issued on Mar. 25, 2008) entitled “Method and apparatus for out-of-order processing of packets”; and U.S. Pat. No. 7,349,332 (Srinivasan, et al; issued on Mar. 25, 2008) entitled “Apparatus for queuing different traffic types”; and United States Patent Application Publication Serial No. 20050240745 (Inventors: Iyer, Sundar, et al.; published on Oct. 27, 2005) entitled: “High speed memory control and I/O processor system”; United States Patent Application Publication Serial No. 20050278512 (Inventors: Ehlig, Peter N., et al.; published on Dec. 15, 2005) entitled “Context switching devices, systems and methods”, United States Patent Application Publication Serial No. 20050240745 (Inventor: Iyer, Sundar, et al.; published on Oct. 27, 2005) entitled “High speed memory control and I/O processor system”; United States Patent Application Publication Serial No. 20040151177 (Inventors: Burton, Tom E., et al.; published on Aug. 5, 2004) entitled “Device to receive, buffer, and transmit packets of data in a packet switching network”; United States Patent Application Publication Serial No. 20040151176 (Inventors: Burton, Tom E., et al.; published on Aug. 5, 2004) entitled “Device to receive, buffer, and transmit packets of data in a packet switching network”; and United States Patent Application Publication Serial No. 20060064508 (Inventors: Panwar, Ramesh, et al.; published on Mar. 23, 2006) entitled “Method and system to store and retrieve message packet data in a communications network” are incorporated herein by reference and for all purposes. In addition, each and all publications, patents, and patent applications mentioned in this specification are herein incorporated by reference to the same extent in their entirety and for all purposes as if each individual publication, patent, or patent application was specifically and individually indicated to be incorporated by reference.

### BRIEF DESCRIPTION OF THE DRAWINGS

These, and further features of the invention, may be better understood with reference to the accompanying specification and drawings depicting the preferred embodiment, in which:

FIG. 1 is a schematic diagram of a first alternate preferred embodiment of the Present Invention, or first version, that includes a microprocessor, an access logic and a DRAM;

FIG. 2 illustrates an organization of a plurality of banks of the DRAM of FIG. 1 into separate pluralities of bins;

FIG. 3A is a value message that specifies an internal bank address of a bin location within each bank of FIG. 2;

FIG. 3B is a command message that specifies a calculate command that directs the calculation logic of the access logic of FIG. 1;

FIG. 4 is a flowchart of an implementation of the first method that may be executed by the system of FIG. 1;

FIG. 5 is a flow chart that depicts alternative or additional aspects of the method of the Present Invention, whereby a counter value is generated;

FIG. 6 is a flowchart of an implementation of a second method that may be executed by the system of FIG. 1;

FIG. 7 is a schematic of circuitry used to synthesize a bank number (address) and an internal bank address of a bin of FIGS. 1 and 2;

FIG. 8 is a schematic of a circuitry of the delay module of FIG. 1 used to synthesize a bank number, i.e., a bank address, and with an internal bank address;

FIG. 9 is a schematic of a method applied by the system of FIG. 1 to select a bank having a smallest latency time;

FIG. 10 is an illustration of a method used by the system of FIG. 1 to synthesize a bank number with an internal bank address to generate an address of a particular bin maintained within a bank specified;

FIG. 11 is a schematic of an alternate round-robin circuitry of the delay module of FIG. 1 used to select a bank having a smallest latency time from a group of banks 0-N of FIG. 1, wherein one unique bank is periodically available at each and every of N+1 clock cycles; and

FIG. 12 is schematic diagram of a representative bin of the plurality of bins of the DRAM of FIG. 1 showing a bin comprising a subcounter maintaining a subvalue.

### DETAILED DESCRIPTION OF A PREFERRED EMBODIMENT

In describing the preferred embodiments, certain terminology will be utilized for the sake of clarity. Such terminology is intended to encompass the recited embodiment, as well as all technical equivalents, which operate in a similar manner for a similar purpose to achieve a similar result.

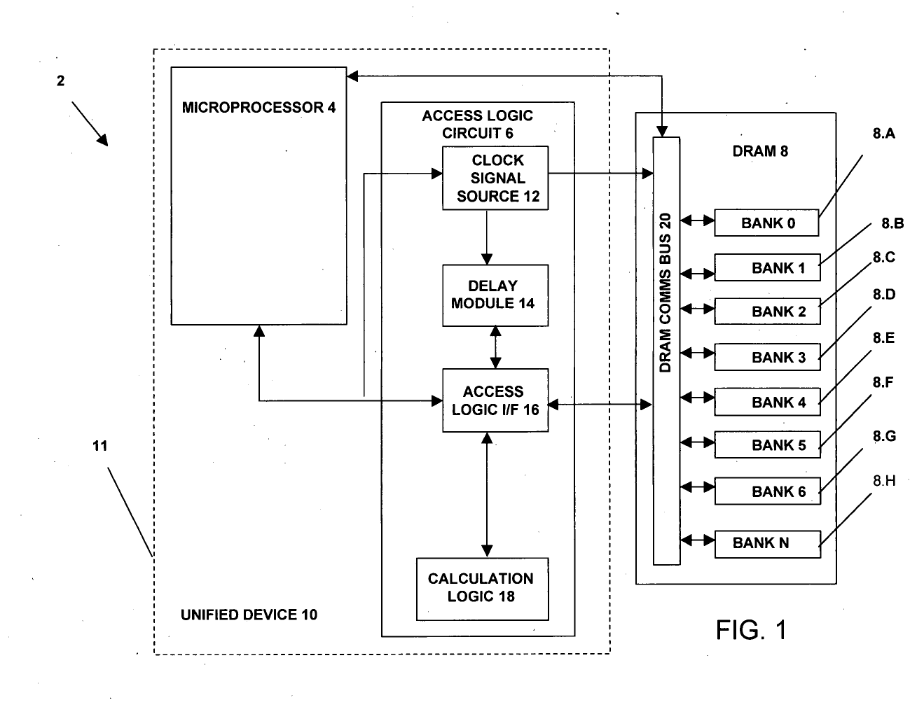

Referring now generally to the Figures and particularly to FIG. 1, FIG. 1 is a schematic diagram of a first alternate preferred embodiment of the Present Invention, or first version 2. A microprocessor 4 is bi-directionally coupled with a memory access logic circuit 6, and the memory access logic circuit 6 is bi-directionally coupled with a dynamic random access memory device 8 (hereafter, “DRAM”). The DRAM 8 may be a part number MT47H1128M8HQ-187E dynamic random access memory device as manufactured by Micron Technologies of Boise, Id., or a K4T1G084QD dynamic memory device as manufactured by Samsung Corporation of Seoul, Korea. In various alternate preferred embodiments of the first version 2, the microprocessor 4 and one or more elements 12-18 of the memory access logic circuit 6 may be comprised within a unified device 10 that is located on a substrate 11, such as a semiconductor die.

The DRAM 8 includes a plurality of banks 8.A-8.H. Each bank 8.A-8.H includes a plurality of bins B.0-B.100K. It is understood that the first bank 8.A includes a first plurality of bins B.0-B.100K and that each other bank 8.B-8.H are includes a separate and unique plurality of bins B.0-B.100K.

The access logic circuit 6 includes a clock signal source 12, an access time delay module 14, an access logic and interface 16 and a calculation logic 18. The access logic and interface 16 is bi-directionally communicatively coupled with both the microprocessor 4 and the DRAM 8. The clock signal source 12 may generate a real time clock pulse or alternatively or additionally receive a clock pulse signal from the microprocessor 4. The clock signal source 6 is communicatively coupled to both the delay module 14 and the access logic interface 16 (hereafter “access logic I/F” 16) and provides a clock signal to the delay module 14 and the access logic I/F 16. The access logic I/F 16 receives counter value processing instructions from the microprocessor 4 and selects which bin B.0-B.100K of which bank 8.A-8.H to read and/or update a subvalue associated with the instant and selected counter value as indicated by or associated with a related counter value processing instruction. The delay module 14 determines the current access time of each of the banks 8.A-8.H and informs the access logic I/F 16 which bank 8.A-8.H presently exhibits a minimal access time. Alternatively or additionally, the delay logic 16 may determine and inform the access logic I/F 16 of one or more bans 8.A-8.H that presently exhibits an acceptably low access time.

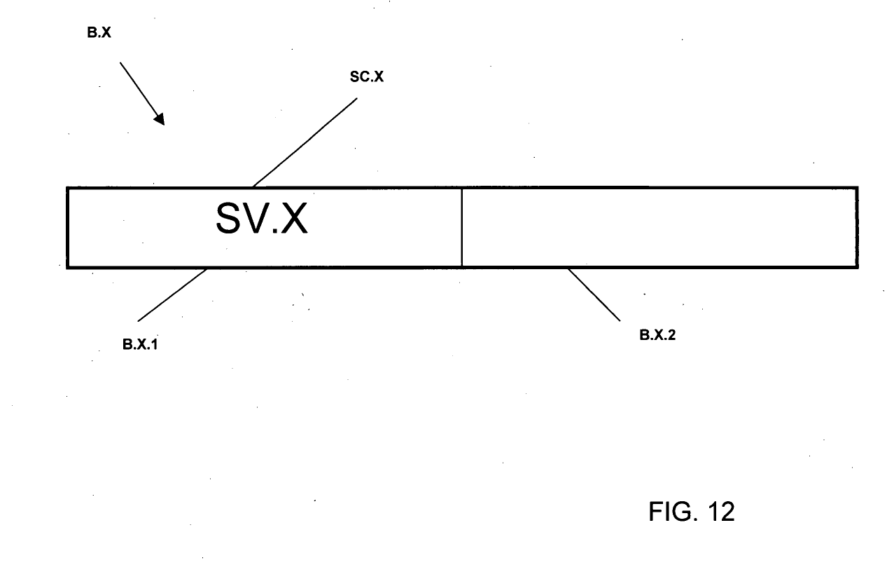

In overview, the microprocessor 4 directs the access logic circuit 6 to update a counter value as stored in the DRAM 8. The delay logic 14 then informs the access logic I/F 16 of which bank 8.A-8.H holding a subcounter S.0-S.7 associated with the instant counter value has the shortest current access time, or optionally of one or more banks 8.A-8.H maintaining subcounter values associated with the instant counter value that have an acceptably short access time. The access logic 16 then accesses the relevant subcounter SC.0-SC.X from a bank 8.A-8.H having either the shortest access time, or in certain alternate preferred embodiments of the method of the present invention, from a bank 8.A-8.H having an acceptably short access time. (Please note that FIG. 12 illustrates that each subcounter SC.X is comprised within a bin B.X, and that each subcounter SC.X and its comprising bin B.X maintain a current subvalue SV.X.) The access logic I/F 16 then reads a relevant current subcounter value SV.0-SV.X of the selected bank 8.A-8.H, updates the current subcounter value SV.0-SV.X and then writes the updated subcounter value SV.Z back into the subcounter from which the relevant current value SV.0-SV.X was most recently read. The updated subcounter value SV.Z may be generated by (1.) the access logic I/F 16 providing an update instruction and/or value to the calculation logic 18, (2.) the access logic I/F 16 providing the current subcounter value SV.0-SV.X to the calculation logic 18, (3.) the calculation logic 18 computing the updated subcounter value SV.Z at least partially on the basis of the update instruction, update value, and/or the current subcounter value SV.0-SV.X; and (4.) providing the updated subcounter value SV.Z from the calculation logic 18 to the access logic I/F 16.

It is understood that the microprocessor 4 may optionally or additionally provide a subcounter update value SV.Z, i.e., an updated subvalue SV.Z, to the access circuit 6, and that the calculation logic 18 of the access circuit 6 may update the selected subcounter SC.0-SC.X on the basis of an algorithm as applied to the update subvalue SV.Z. Additionally or alternatively, the access circuit 6 may simply update the current subvalue SV.0-SV.X stored of the selected subcounter SC.0-SC.X by incremented or decrementing the stored value SV.0-SV.X of the selected subcounter SC.0-SC.X.

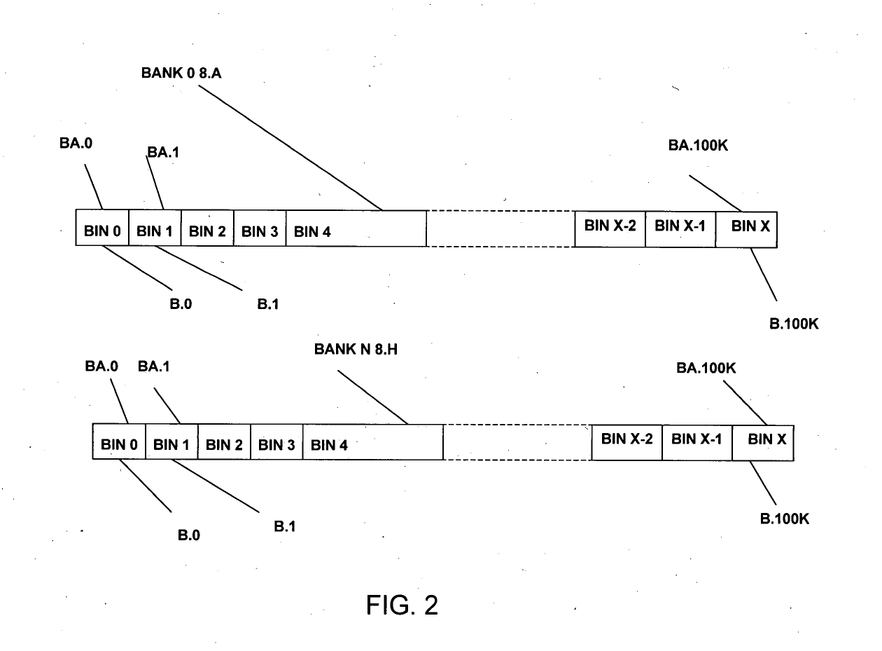

Referring now generally to the Figures and particularly to FIG. 2, FIG. 2 illustrates an organization of the DRAM 8. A DRAM communications bus 20 (hereafter “DRAM bus” 20) bi-directionally communicatively couples each bank 8.A-8.H to the access logic circuit 6 and the microprocessor 4. The memory resources of each bank 8.A-8.H are divided into a plurality of bins B.0 through B.100K and havening ordered to have sequential bin addresses BA.0-BA.100K, wherein each first bin B.1 of each bank 8.A-8.H has an identical internal bank address BA.1. Furthermore each sequential bin B.2-B.100K has an internal bank address BA.2-BA.100K wherein bin B.100K is designated as bin X and has an internal bank address of 100K. Each unique set of subcounters SC.0-SC.X comprises bins B.0-B.100K that shares a same internal bank address BA.0-BA.100K. For example, each subcounter of a first set of subcounters SC.0.1-SC.0.X assigned to maintain a first counter value are each assigned within a different bank 8.A-8.H and share a same internal bank address BA.0.

Each bank 8.A-8.H comprises a unique plurality of bins B.0-B.100K wherein each bin stores a subcounter value SV.0-SV.X, i.e., a subvalue SV.0-SV.x. It is understood that the internal bank address BA.0-BA.100K of each bin B.0-B.100K within a bank 8.A-8.H (hereafter “bank address”) is identical for a bin B.0-B.100K that is assigned to maintain a subvalue SV.0-SV.X of a same counter value.

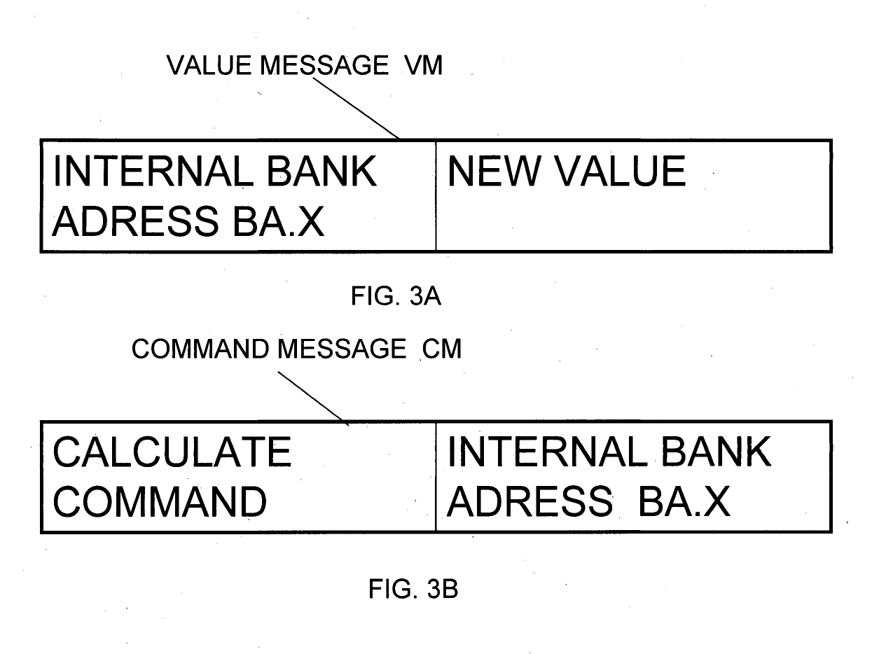

FIG. 3A is a value message VM that specifies an internal bank address BA.X specifying a location of a bin B.0-B.100K within each bank 8.A-8.H, and a new value NV by which a subcounter SC.0-SC.X of the selected bin B.0-B.100K shall be updated, e.g., added to or subtracted from.

FIG. 3B is a command message CM that specifies a calculate command that directs the calculation logic 18 of the access logic circuit 6 to read a bin location B.0-B.100K of each bank 8.A-8.H at a specific internal bank address BA.0-BA.100K, and to calculate therefom the resultant value of the processed subvalue SV.Z. The command message CM is transmitted from the microprocessor 4 to the access logic I/F 16.

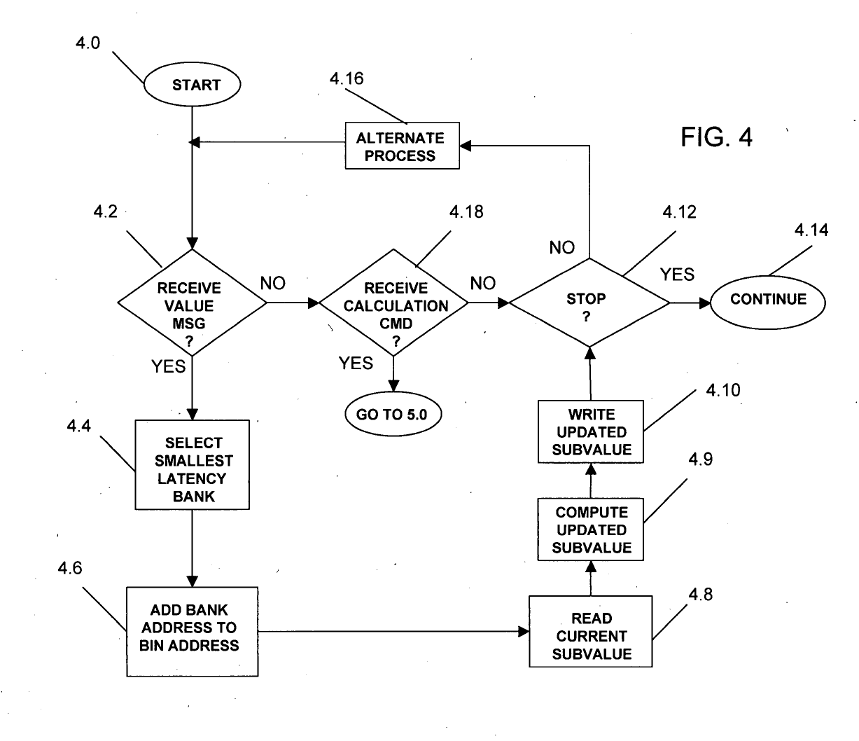

Referring now generally to the Figures and particularly to FIG. 4, FIG. 4 is a flowchart of an implementation of the first method that may be executed by the system 2 of FIG. 1. In step 4.2 the access logic 6 determines whether the microprocessor 4 has transmitted a value message VM. When the access logic 6 determines in step 4.2 that the microprocessor 4 has transmitted a value message VM, the system proceeds on to step 4.4 to determine the bank 8.A-8.H having the smallest latency period. In various alternate preferred embodiments of the method of the present invention a bank 8.A-8.H having an acceptably low access time is selected for access and updating in step 4.4, rather than the shortest access time. In step 4.6 the access logic 6 synthesizes the internal bank address BA.X received in the value message of step 4.2 and the bank number BN.0-BN.N selected in step 4.4 as having the shortest current latency time, or alternatively an acceptably low access time. In step 4.8 the current subcounter value SV.0-SV.X of the relevant subcounter SC.X of the bank 8.A-8.H selected in step 4.4 is read into the access logic 6. In step 4.9 the access logic 6 employs the calculation logic 18 to calculate an updated subcounter value SV.Z. In step 4.10 the subcounter SC.X of the bin B.0-B.100K indicated in step 4.6 is updated by writing the updated value SV.X calculated in step 4.9 into the bin B.0-B.100K from which the subvalue SV.X was read in step 4.8. The system 2 determines in step 4.12 whether to cease updating the bins 8.A.1-8.H.100K of the DRAM 8 in step 4.12, as per step 4.14, or to proceed on to alternate processing in step 4.16.

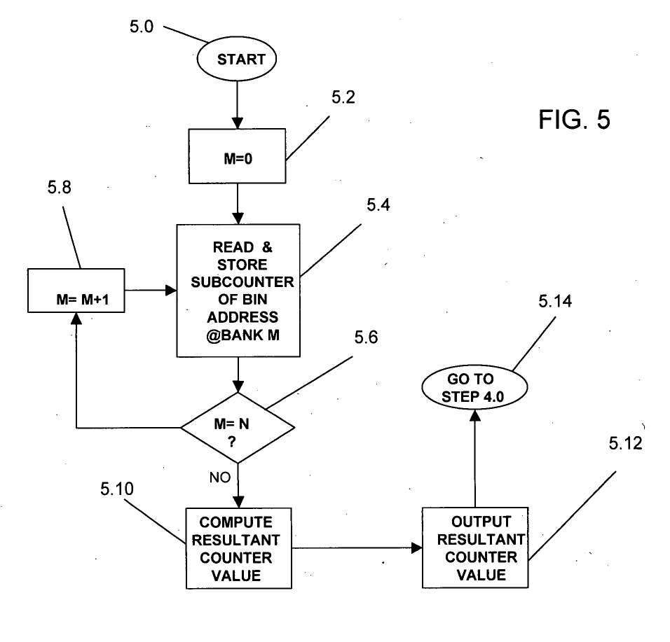

When the access logic 6 determines in step 4.2 that the microprocessor 4 has not transmitted a value message VM, the system 2 proceeds on to step 4.18 to determine whether the access logic 6 has received a calculation command message CM. When the access logic 6 determines in step 4.18 that the microprocessor 4 has not issued a calculation command message CM, the access logic 6 proceeds on to step 4.12. When the access logic 6 determines in step 4.18 that the microprocessor 4 has issued a calculation command message CM, the access logic proceeds from step 4.18 to step 5.0 of FIG. 5.

Referring now generally to the Figures and particularly to FIG. 5, FIG. 5 is a flowchart that depicts alternative or additional aspects of the method of the Present Invention, wherein a counter value is generated. Each assigned subcounter SC.0-SC.8 of the subcounter set assigned to maintain the instant counter value is read from a selected bin assigned to the relevant counter value and stored in the calculation logic 18 in steps 5.4 through 5.8. After each subcounter assigned to the instant counter value has been read from the DRAM 8, the calculation logic 18 of the access logic 6 computes the resultant counter value in step 5.10. This calculation of step 5.10 may be a simple addition of the subvalues read and stored in steps 5.4 through 5.8.

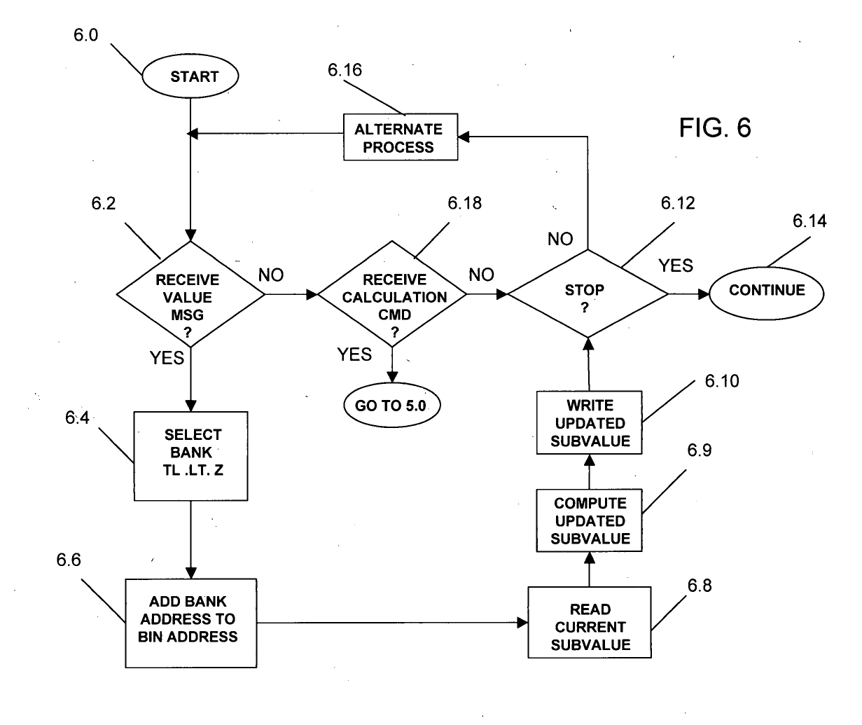

Referring now generally to the Figures and particularly to FIG. 6, FIG. 6 is a flowchart of an implementation of a second alternate preferred embodiment of the method of the present invention, or second method, that may be executed by the system of FIG. 1. In step 6.2 the access logic 6 determines whether the microprocessor 4 has transmitted a value message VM. When the access logic 6 determines in step 6.2 that the microprocessor 4 has transmitted a value message VM, the system proceeds on to step 6.4 to select a bank 8.A-8.H having a latency period less than a set time value of Z. In step 6.6 the access logic 6 synthesizes the internal bank address BA.X received in the value message VM of step 6.2 and the bank number BN.0-BN.N selected in step 6.4 as having the shortest current latency time, or alternatively an acceptably low access time. In step 6.8 the current subcounter value SC.X of the relevant bin B.0-B.100K of the bank 8.A-8.H selected in step 6.4 is read into the access logic 6. In step 6.9 the access logic 6 employs the calculation logic 18 to calculate an updated subcounter value SV.X. In step 6.10 the subcounter of the bin B.X indicated in step 6.6 is updated by writing the updated value SV.Z calculated in step 6.9 into the bin B.X from which the current subvalue SV.X was read in step 6.8. The system 2 determines in step 6.12 whether to cease updating the banks 8.A-8.H of the DRAM 8 in step 6.12, as per step 6.14, or to proceed on to alternate processing in step 6.16.

When the access logic 6 determines in step 6.2 that the microprocessor 4 has not transmitted a value message VM, the system, 2 proceeds on to step 6.18 to determine whether the access logic 6 has received a calculation command message CM. When the access logic 6 determines in step 6.18 that the microprocessor 4 has not issued a calculation command message CM, the access logic 6 proceeds on to step 6.12. When the access logic 6 determines in step 6.18 that the microprocessor 4 has issued a calculation command CM, the access logic 6 proceeds from step 6.18 to step 5.0 of FIG. 5.

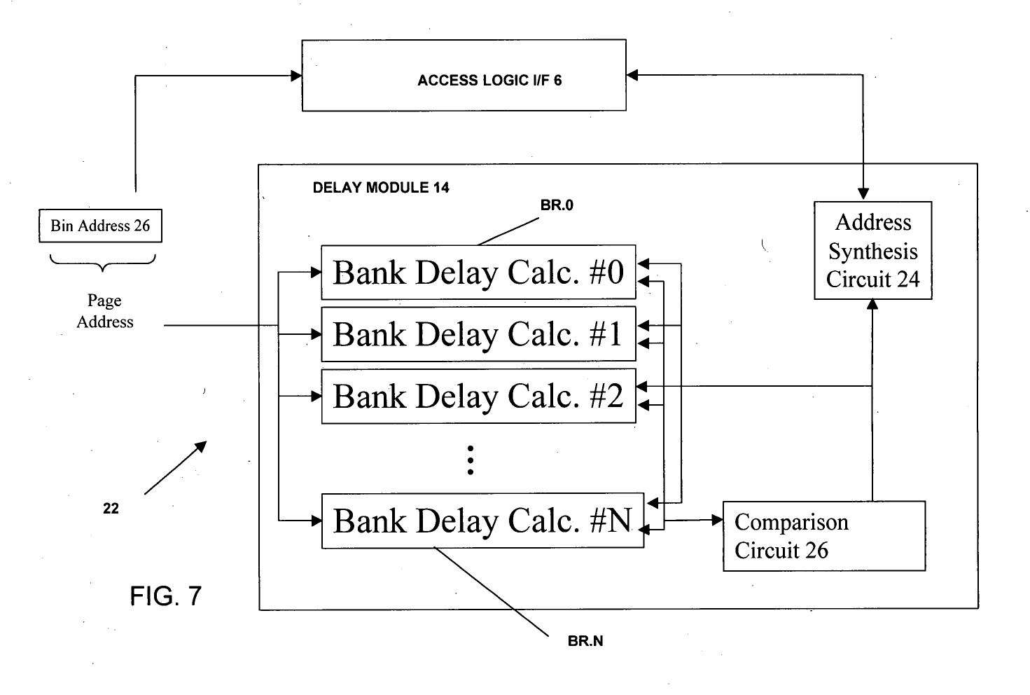

Referring now generally to the Figures and particularly to FIG. 7, FIG. 7 is a schematic of a first optional addressing circuitry 22 used to synthesize a bank number 0-N (address) and an internal bank address BA.X of a bin B.X. The microprocessor 4 provides a bin address BA.X to the access logic I/F 16. The delay module 14 then calculates the bank number 0-N of the bank 8.A-8.H having the shortest latency time, or alternatively a bank 8.A-8.H having an acceptable access time latency, by a latency time comparison circuit 26. The selected bank number 0-N and the internal bank address BA.X provided by the microprocessor 4 are synthesized to generate a full bin address by an address synthesis circuit 24 of the access circuit 6, and the full bin address is provided to and applied by the access logic I/F 16 to read from and/or right to a bin B.0-B.100K of the selected bank 8.A-8.H.

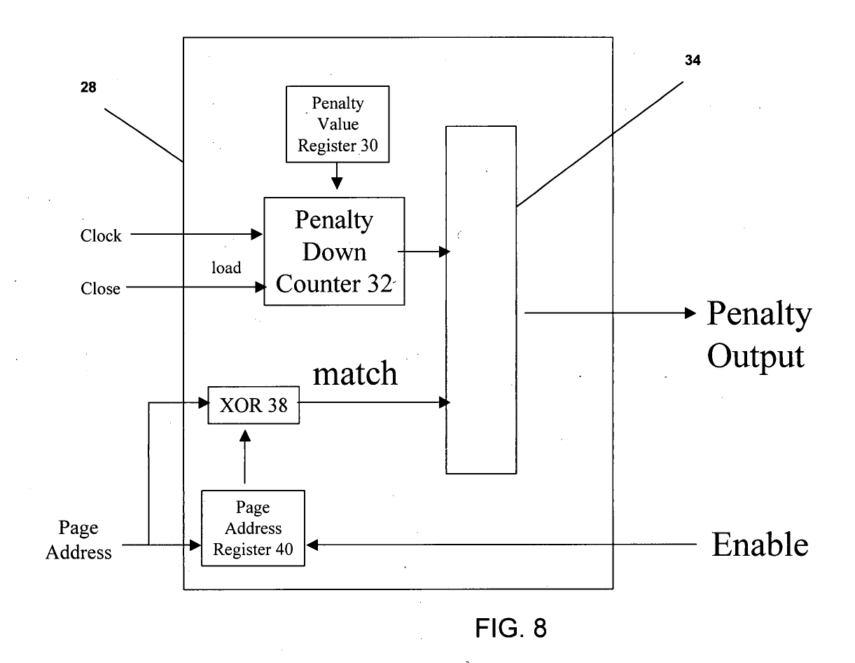

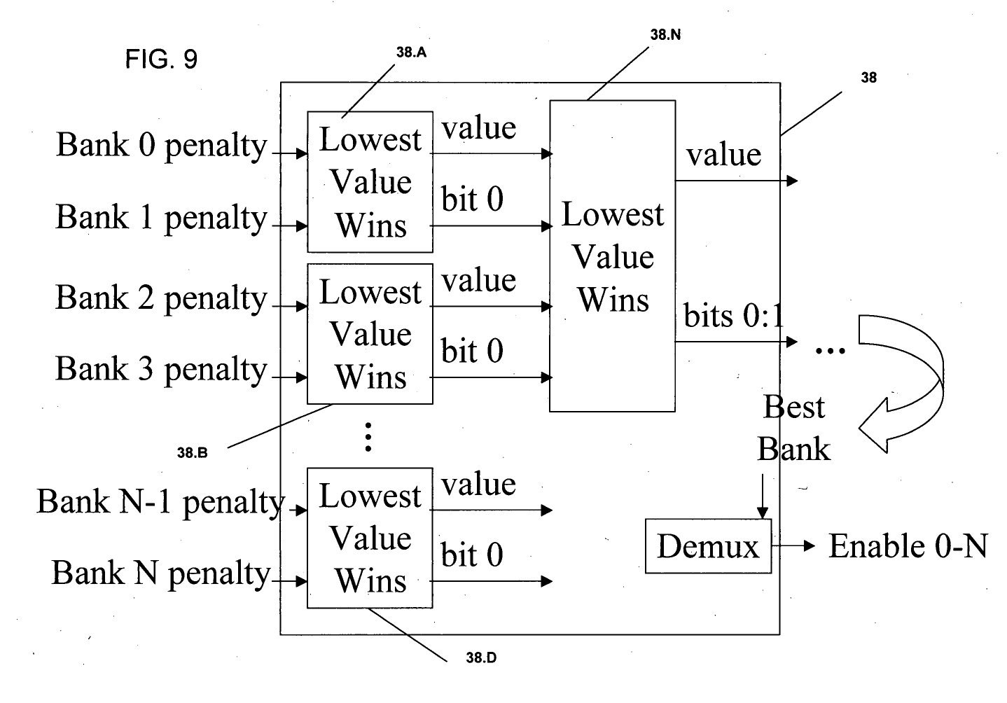

Referring now generally to the Figures and particularly to FIG. 8, FIG. 8 is a process diagram of an optional access penalty circuit 28 of the access logic 6 used to determine the access latency of an individual bank 8.A-8.H to which the access penalty circuitry 28 is dedicated. A penalty value register 30 provides an initial latency time value to a penalty down counter 32. A clock signal from the clock signal source 12 is received by the penalty down counter 32 and decrements a penalty value maintained by the penalty down counter with each clock cycle. A penalty comparison circuit 34 provides the current penalty value to a bank selection circuit 36 of FIG. 9. A NOT OR logic circuit 38 page address provides a match signal to the penalty comparison circuit 34.

Referring now generally to the Figures and particularly to FIG. 9, FIG. 9 is a process diagram of a method applied by the system 2 by means of an optional bank selection circuit 36 applied to select a bank 8.A-8.H having a smallest latency time. The output of each penalty access circuit 28 is provided to one of a plurality of penalty value pair comparison circuits 38.A-38.D. The eight separate penalty outputs, one from each of the penalty access circuit 28 that are each dedicated to a unique and separate bank 8.A-8.H, are input into a plurality of latency value circuits 38.N. The plurality of latency value circuits 38.A-38.N are configured and organized to determine the lowest current latency access time value and to direct the access circuit 6 to access a bank 8A.-8.H having the lowest current latency access time value.

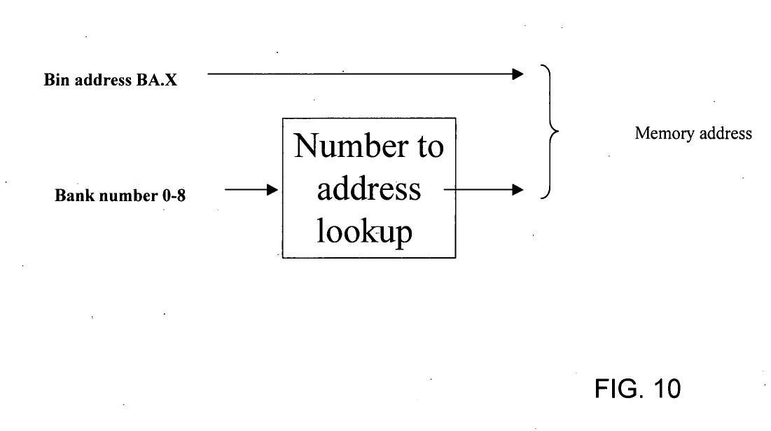

Referring now generally to the Figures and particularly to FIG. 10, FIG. 10 is an illustration of a third alternate preferred embodiment of the method of the present invention used to synthesize a bank number 0-N with an internal bank address BA.X to generate an address of a particular bin maintained within a specific bank 8.A-8.H. The access circuit 6 is configured to receive a bin address BA.X, i.e., an internal bank address BA.X, and synthesize the received bank address BA.X with a bank number 0-N to form an address of a particular bin B.0-B.100K of a specific bank 8.A-8.H of the DRAM 8.

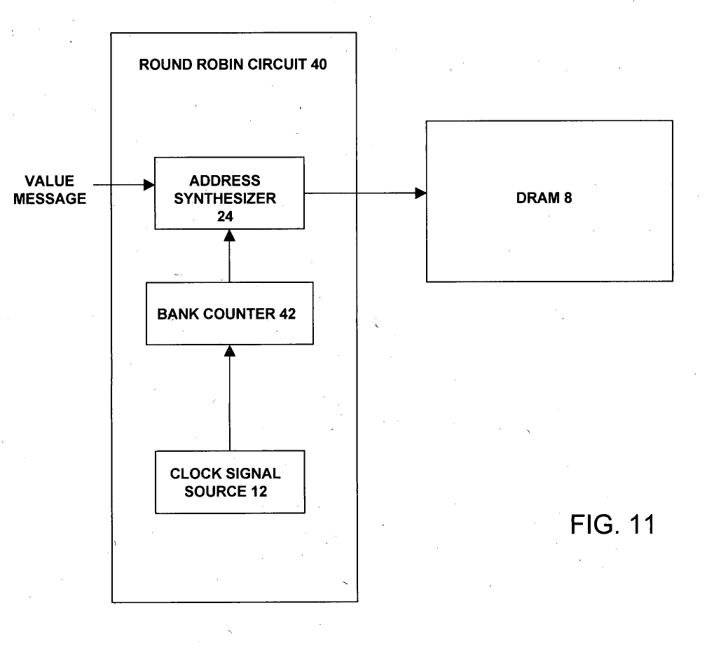

Referring now generally to the Figures and particularly to FIG. 11, FIG. 11 is a schematic of an optional additional or alternative round-robin circuit 40 used to select a bank 8.A-8.H having a smallest latency time from a group of eight banks 8.A-8.H, wherein one unique bank 8.X is periodically available at every of eighth clock cycles as provided by the clock signal source 12 to the DRAM 8. It is understood that a bank selection value maintained by the bank counter 42 of the round robin circuit 40 indicates at each clock cycle which of the banks 8.A-8.H is exhibiting the smallest access time. For example, where the DRAM 8 has N banks, and the DRAM 8 is configured to cause each bank in an ordered time sequence to exhibit a minimal access latency time, the bank counter 42 will count from 0 to N−1 to maintain a bank value that informs the address synthesizer 24 which bank of the DRAM 8 has the smallest time latency value. As the bank counter 42 receives clock pulses from the clock signal source 12, the bank counter 42 will update the value maintained therein to indicate the succeeding bank to present the lowest access latency time.

Referring now generally to the Figures and particularly to FIG. 12, FIG. 12 is schematic diagram of a representative bin B.X of the plurality of bins B.0-B.100K of one of the blocks 8.A-8.H the DRAM 8 of FIG. 1 showing a bin B.X comprising a subcounter SC.X maintaining a subvalue SV.X. The bin B.X is included within a particular bank 8.X of the DRAM 8, and comprises a subcounter SC.X that maintains the current subvalue SV.X, i.e. a sub counter value SV.X in a first section B.X.1 of the instant bin B.X. An optional second section B.X.2 of the instant bin B.X contains additional information as directed by the system 2.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

We claim:

1. In a computational system having a control module and a memory, the control module communicatively coupled with the memory, a method for dynamically maintaining a value, the method comprising:
a. establishing at least two sub counters within the memory;
b. determining a sub counter having an acceptably small latency required to increment a sub counter value stored therein; and
c. updating a sub counter value of the sub counter determined in step b to have an acceptably small latency required to increment a sub counter value.

2. The method of claim 1, further comprising:
d. determining which sub counter has the smallest latency required to increment a sub counter value; and
e. updating the sub counter value determined to have the smallest latency.

3. The method of claim 1, wherein each of a plurality individual delay time registers are uniquely dedicated to one of a plurality of sub counters, and each of the plurality individual delay time registers maintains an access time delay value for its dedicated sub counter.

4. The method of claim 1, wherein the memory is a dynamic random access memory (DRAM).

5. The method of claim 4, wherein the DRAM comprises a plurality of banks, and at least one sub counter is established within each of N banks.

6. The method of claim 5, wherein at least one sub counter established within each of N banks is comprised within a same internal page address.

7. The method of claim 6, wherein a sub counter address of each sub counter is synthesized from data containing a bank address and a page address.

8. The method of claim 6, wherein the value is calculated dynamically by summing every value of the at least two sub counters.

9. The method of claim 4, wherein each of a plurality of individual delay time registers are uniquely dedicated to an individually associated sub counter of a plurality of sub counters, and each of the plurality individual delay time registers maintains an access time delay value for an individually associated sub counter.

10. The method of claim 9, wherein the determination of a sub counter exhibiting the smallest latency for value incrementing is determining by comparing access time delay values of each of the plurality individual delay time registers, and selected the sub counter having a shortest latency value in an associated delay time register.

11. In a computational system having a control module and a memory, a method for dynamically incrementing a value, the method comprising:
establishing a plurality of bins within the memory;
assigning a null value to each bin;
determining which bin has the smallest access latency time to increment a bin value; and
incrementing the bin determined to have the smallest latency time.

12. The method of claim 11, wherein the memory is a dynamic random access memory (DRAM).

13. The method of claim 12, wherein N bins of the plurality of bins are each located in a separate bank of the DRAM.

14. The method of claim 13, wherein each of the N bins is addressable within a page of each bank has an identical internal bank address.

15. A computational system comprising:
a memory, the dynamic random access memory (DRAM) comprising a plurality of banks, each bank having a plurality of pages, each bank having at one least page comprising a bin assigned to maintain a sub counter value;
a plurality of time latency counters, the plurality of time latency counters communicatively coupled with the memory, wherein each time latency counter is individually assigned to a unique bin, and each time latency counter holds a value indicative of an access time latency to an assigned bin; and
a comparison circuit, the comparison circuit communicatively coupled with the memory and the plurality of time latency counters, and configured to compare the values of the plurality of time latency counters to determine the bin having the smallest time latency value.

16. The computational system of claim 15, further comprising at least one initial latency value register, the initial latency value register communicatively coupled with the memory and at least one time latency counter, and configured to write an initial latency value into the at least one time latency counter when a page comprising the bin is closed.

17. The computational system of claim 15, further comprising a real time clock, the real time clocked communicatively coupled with the memory and at least one time latency counter, and the at least one time latency counter configured to reduce a stored latency value upon detection of a real clock cycle completion.

18. The computational system of claim 15, wherein N banks of the plurality of banks have a bin maintained at a same internal bank address.

19. The computational system of claim 18, wherein the same internal bank address comprises a same internal page address.

20. The computational system of claim 19, further comprising an address synthesizer, the address synthesizer configured to increment a bin of a plurality of bins having a same internal bank address, wherein the incremented bin has a smallest latency value of the plurality of bins having a same internal bank address.
